(19) United States
(12) Patent Application Publication
(10) Pub. No.: US 2022/0015356 A1
(43) Pub. Date: Jan. 20, 2022

(54) AQUEOUS SOLUTIONS OF POORLY SOLUBLE PESTICIDES USING POLYALKYOXYLATED ALCOHOLS

(71) Applicant: Dow Global Technologies LLC, Midland, MI (US)

(72) Inventors: Thomas H. Kalantar, Midland, MI (US); Michael P. Tate, Midland, MI (US); Min Zhao, Collegeville, PA (US); Yuri Alencar Marques, Lake Jackson, TX (US); Michael L. Tulchinsky, Midland, MI (US); Adam H. Xiong, Mount Pleasant, MI (US)

(21) Appl. No.: 17/295,153

(22) PCT Filed: Nov. 25, 2019
(86) PCT No.: PCT/US2019/062951

§ 371 Date: May 19, 2021

Related U.S. Application Data
(60) Provisional application No. 62/777,820, filed on Dec. 11, 2018.

(51) Int. Cl. A01N 25/02; A01N 43/653; A01N 47/24

(52) U.S. Cl. CPC A01N 25/02; A01N 47/24; A01N 43/653

(57) ABSTRACT

Disclosed is a composition comprising an agricultural active ingredient that is water insoluble or poorly soluble in water; a polyalkoxylated alcohol having the formula R—O(AO)—H where R is a alkyl, alkenyl, aryl, aralkyl, or heterocyclic group having 1-25 carbons and where AO is a polyoxyalkylene chain having “m” oxyalkylene groups having four to 10 carbon atoms oxybutylene (HAO) and “n” oxyethylene (EO) groups, where m is at least 1, n is at least 2, and m+n is no more than 200; and either water, a solvent which is at least partially miscible with water, or both. Also disclosed is a method of using the composition to control pests by spraying.

### CROSS REFERENCE TO RELATED APPLICATIONS

This application claims the benefit of U.S. Application No. 62/777,820, filed on Dec. 11, 2018, which is incorporated herein by reference in its entirety.

### FIELD OF THE INVENTION

The field of this invention is aqueous solutions of poorly soluble active pesticides using polyalkyoxylated alcohols and their use in pest control.

### BACKGROUND

Many poorly soluble pesticides present difficulties in the preparation of aqueous solutions for applications in to areas where pest control is desired—e.g. agricultural fields, orchards, etc. This may be due to one or more of the following: lack of solubility in solvent systems that can form stable solutions, dispersions or emulsions in water; solubility in polar solvents that are partially miscible in water but when diluted with water for application form precipitates that can plug spray nozzles or quickly settle to the bottom of storage or spray tanks; instability in long term storage time; and possible limited efficacy in the application onto agricultural fields.

Various approaches have been proposed to obtain various stable agricultural chemical formulations (see e.g. U.S. Pat. Nos. 6,451,731; 9,204,643; US20160235071; U.S. Pat. Nos. 7,977,278; 7,407,667; 7,655,599; and US 20080312290). While not typically dispensed in aqueous solution, various approaches have also been proposed for solubilizing pharmaceutical actives to enhance processability (See e.g. U.S. Pat. Nos. 7,776,360; 9,592,294; Novel Excipient Solubilizers for Poorly Soluble Drugs, Kalantar et. al. Controlled Release Society, Jul. 13-16, 2017).

Nevertheless, a need remains for effective means of controlling precipitation of poorly water soluble pesticides to enhance long term stability during storage and to prevent plugging of spraying apparatuses or settling of precipitated active ingredients.

### SUMMARY OF THE INVENTION

Disclosed herein is the use of polyalkoxylyated alcohols to solubilize poorly water soluble agricultural active ingredients. Specifically, disclosed is a liquid formulation comprising an agricultural active ingredient that is insoluble or poorly soluble in water; a polyalkoxylated alcohol having the formula R—O(AO)—H where R is an alkyl, alkenyl, aryl, aralkyl, or heterocyclic group having 1-25 carbons and where AO is a polyoxyalkylene chain having “m” oxyalkylene groups of alkylenes having from 4 to 10 carbon atoms and “n” oxyethylene (EO) groups, where m is at least 1, n is at least 2, and m+n is no more than 200; and either water, a solvent which is at least partially miscible with water, or both.

As used herein, at least partially miscible with water means it is miscible in any amounts (fully miscible) or the solvent is soluble in water in amounts of amounts of from 0.5 or from 1 or from 2 or from 3 or from 4 or from 5 or from 10 weight percent up to 30 or up to 20 weight percent based on total weight of water and solvent.

### DETAILED DESCRIPTION OF THE INVENTION

The use of polyalkoxylyated alcohols to solubilize active ingredients that are poorly soluble in water or aqueous media, as disclosed herein, can be helpful with water insoluble or poorly soluble agricultural active ingredients. As used herein agricultural active ingredients means a chemical compound used in agriculture, horticulture and pest management for protection of crops, plants, structures, animals and humans against unwanted organisms such as fungal and bacterial plant pathogens, weeds, insects, mites, algae, nematodes and the like. Specifically, active ingredients used for these purposes include fungicides, bactericides, herbicides, insecticides, miticides, algaecides, nematocides and fumigants. The term “agricultural active ingredient” also includes insect repellants and attractants and pheromones, modifiers of plant physiology or structure, zoospore attractants and herbicide safeners.

As used herein agricultural active ingredients or compounds are considered poorly soluble if they precipitate or crystallize at concentrations at which the use is desired. For example, if a compound is most useful at concentrations or dosages of 50 mg/L but significant precipitation occurs at 20 mg/L that compound would be considered poorly soluble. Thus, the agricultural active compound can have a solubility in water or aqueous medium of up to 1000, up to 700, up to 500, up to 300, up to 200, up to 100, up to 50, up to 40, up to 30, up to 20 or up to 10 parts per million. In the alternative, the agricultural active compound can have a solubility in aqueous medium or water of up to 50, or up to 20 or up to 10 or up to 1 mg/L. The solubility of the agricultural active compound in an aqueous medium can be determined quantitatively e.g. by turbidity as shown in the examples below or by high pressure liquid chromatography. In the latter method for example, a solid agricultural active (potentially with solid excipients) is placed in an aqueous medium, after stirring for a period of time the a sample would be injected into an HPLC system with an appropriate column and the area at the expected retention time based on a control sample of the active at a known concentration is evaluated.

The use of the polyalkoxylated alcohol can assist in the use of poorly water soluble agricultural active ingredients in spray applications on agricultural fields, orchards or the like. For example, the use of the polyalkoxylated alcohol can inhibit flash precipitation that would occur if a solvent based formulation is diluted with water or can enhance solubility of solid actives. The use of the polyalkoxylated alcohol may provide one or more of the following benefits, for example, 1) extended stability of aqueous agricultural active systems compared to systems that do not contain the polyalkoxylated alcohols; 2) produce a controlled precipitation of the agricultural active ingredients generating a controlled fine particle size distribution; 3) produce finer agricultural active ingredient particles, droplets, or precipitates in aqueous systems that do not plug nozzles and present slower settling rates compared to systems that do not contain the polyalkoxylated; and/or 4) hinder and/or delay the formation of large precipitates that generate problems for spray applications. In addition, the enhanced solubility could enhance efficacy if for example the mode of action includes uptake of the agricultural active ingredient by the plant or animal which uptake is enhanced by higher concentration of the active in solution or if more uniform distribution is required than is attainable by particulates.

The polyalkoxylated alcohol has the formula R—O-(AO)—H. R can be selected from an alkyl of from 1, or from 2, or from 3, or from 4, or from 5, or from 6, or from 8 to 20, or to 18, or to 16, or to 14, or to 12, or to 10 carbon atoms (including cyclic alkyl of 8 to 18 or to 12 carbon atoms). R can be an alkenyl of from 2, or from 3, or from 4, or from 5, or from 6, or from 8 to 18, or to 12, or to 10 carbon atoms (including cyclic alkenyl of 8 to 18 or to 12 carbon atoms). R can bean aryl of from 6 to 18 or to 12 carbon atoms. R can be an aralkyl of from 7 to 12 carbon atoms. R can be an arylalkenyl of from 8 to 18 or to 14 carbon atoms. R can be a heterocyclic group having 1-25 carbons. The alkyl, alkenyl, aryl, aralkyl, and/or arylalkenyl can be unsubstituted. R can be an unsubstituted alkyl of 8 to 15 carbon atoms, e.g. 8 carbon atoms, such as ethylhexyl; 10 carbon atoms, such as myrtenyl or the alkyl derived from nerol; 12 carbon atoms such as dodecyl; 15 carbon atoms such as derived from farnesol. The aralkyl can be an unsubstituted group having for example 9 carbon atoms, such as cinnamyl. The alkyl, alkenyl, aryl, aralkyl, arylalkenyl can be substituted. “Substituted” as used here includes additional pendant alkyl or aryl groups and/or groups which do not negatively affect alkylation, such as alkoxy groups or cyano groups. Groups which may interfere with alkoxylation should be avoided. AO is a polyoxyalkylene chain having “m” oxyalkylene groups of alkylenes having from 4 to 10 carbon atoms and “n” oxyethylene (EO) groups (e.g. —C₂H₄O—), where m is at least 1, n is at least 2, and m+n is no more than 200. The oxyalkylene group of alkylenes having from 4 to 10 carbon atoms is referred to herein as a higher oxyalkylene (or HAO). The HAO can have from 4 to 8 or from 4 to 6 carbon atoms. The HAO can have 4 carbon atoms (i.e. is oxybutylene, e.g. —CH₂CH(C₂H₅)O—, referred to herein as BO).

The AO can be blocky in that it will have an EO rich block and a block rich in the HAO, which is preferably BO. By EO rich block is meant that at least 55, at least 60, at least 65, at least 70, at least 75, at least 80, at least 85, at least 90 or at least 95 percent of the groups in the block are EO groups. EO rich blocks are helpful in ensuring good water solubility. Similarly, for an HAO rich block that block is rich in mer units based on the HAO, such that at least 55, at least 60, at least 65, at least 70, at least 75, at least 80, at least 85, at least 90 or at least 95 percent of the groups are HAO. For example a BO rich block is meant that at least 55, at least 60, at least 65, at least 70, at least 75, at least 80, at least 85, at least 90 or at least 95 percent of the groups in the block are BO groups. Alternatively, the AO group may be a block copolymer having separate EO blocks and AO (e.g., BO) blocks.

“m” can be at least 2, or at least 3, or at least 4 and can be up to 40, or up to 30, or up to 20, or up to 15, or up to 10. “n” can be at least 3, or at least 5, or at least 10, or at least 15 up to 100, or up to 80, or up to 50, or up to 40, or up to 35. “m/n” can be from 0.1, or from 0.15, or from 0.2, up to 1, or up to 0.7, or up to 0.6, or up to 0.5.

The number average molecular weight (Mn) of the polyalkoxylated alcohols can be at least 500, or at least 750, or at least 1000 g/mol and can be no more than 4000 or no more than 3500 g/mol. The weight average molecular weight (Mw) of the polyalkoxylated alcohols can be at least 1000, or at least 1250, or at least 1500 g/mol and can be no more than 5000, or no more than 4500, or no more than 4000 g/mol. Molecular weight can be measured by Gel Permeation Chromatography (GPC).

Suitable water miscible solvents include but are not limited to N-Methyl-2-pyrrolidone, ethylene glycol monobutyl ether, ethyl lactate, gamma-butyrolactone, propylene glycol, propylene glycol methyl ether, tetrahydrofurfuryl alcohol, 2-ethoxyethanol, dimethyl sulfoxide, 1-methoxy-2-propanol, 2-butoxyethanol, dipropylene glycol methyl ether, n-propanol, acetone.

Suitable water soluble solvents (i.e. partially water miscible solvents) include but are not limited to acetophenone, butyl lactate, cyclohexanone, propylene carbonate, methyl isobutyl ketone, n-butanol, ethylene glycol n-butyl acetate, ethylene glycol phenyl ether.

Combinations of water miscible solvents, water soluble solvents with each other and/or with poorly water soluble co-solvents such as, for example, fatty acid methyl esters, 2-ethylhexanol, 2,2,4-Trimethyl-1,3-pentanediol monoisobutyrate could be used.

The amount of polyalkoxylated alcohol can be at least 50, at least 51, at least 52, at least 53, at least 54, at least 55, at least 60, or at least 65 mole percent or and no more than 80 or no more than 75 mole percent based on total moles of polyalkoxylated alcohol and pesticide. Alternatively, the amount of polyalkoxylated alcohol can be at least 20, or at least 30, or at least 40, or at least 50, or at least 60, or at least 70 up to 95, up to 94, up to 93, up to 92, up to 91 or up to 90 percent by weight based on total weight of the polyalkoxylated alcohol and the agricultural active.

The concentration of the polyalkoxylated alcohol can be at least 0.5, or at least 1.5, or at least 5 weight % based on total weight of the formulation. The concentration of the polyalkoxylated alcohol can be up to 50, or up to 40, or up to 30, or up to 20, or up to 10 weight percent based on total weight of the formulation. The more concentrated formulations may be good for storage and transport and may be diluted with water to the desired dosage before application.

The amount of water may be 0 weight percent (if a solvent is present) or can be at least 0.01, at least 0.1, at least 1, at least 5, at least 10, at least 15, at least 20, at least 25, at least 30, at least 35, at least 40, at least 50, at least 60, at least 70, at least 80 or 90 weight percent based on total weight of the formulation. The amount of water can be up to 99.99 or up to 99.9 or up to 99, or up to 95 or up to 90 weight percent based on total weight of the formulation. The lower amounts of water are useful for transportation and storage. The higher amounts of water may be useful for applications to the area where pest control is desired.

The amount of solvent can be 0 weight percent (if water is present) or can be at least 0.01, at least 0.1, at least 1, at least 5, at least 10, at least 15, at least 20, at least 25, or at least 30 weight % and can be up to 90, up to 80, up to 70, or up to 60 weight percent based on total weight of the formulation.

The combination of the agricultural active and the polyalkoxylated alcohol can be at least 10, at least 50, at least 100, at least 200 parts per million (ppm) by weight and can be up to 100, up to 50, up to 10, up to 5, or up to 1 pails per hundred (pph) by weight in a solvent or in an aqueous medium (including water with no solvent) based on total weight of the formulation.

In agricultural applications, for example, the formulation may also comprise a partially or fully water miscible solvent. Applications that are “in-can” applications frequently include a solvent. This formulation may further include water or may be diluted with water prior to application to the intended area where agricultural active protection is desired. Without the presence of the polyalkoxylated alcohol, the dilution with water might cause the poorly soluble active to precipitate.

Alternatively, the agricultural active ingredient and polyalkoxylated alcohol could be provided in solid particles which are added to a tank with water prior to application to the location where the agricultural active ingredient protection is desired (e.g. field or warehouse). This embodiment could be formed by mixing the polyalkoxylated alcohol and agricultural active ingredient together such as by dissolving in a common solvent and removing that solvent, or by spray drying together, or other such means to make a solid or semi-solid composition that can be diluted in a tank for application to a crop or field.

The aqueous solution including the active and the polyalkoxylated alcohol can be applied by spraying.

In addition to the agricultural active ingredient, the polyalkoxylated alcohol, and the solvent and/or water, the formulations as disclosed here may include additional active materials, and additional inactive materials.

Examples of insecticides include antibiotic insecticides such as allosamidin and thuringensin, macrocyclic lactone insecticides such as spinosad, spinetoram and 21-butenyl spinosyns; avermectin insecticides such as abamectin, doramectin, emamectin, eprinomectin, ivermectin and selamectin; milbemycin insecticides such as lepimectin, milbemectin, milbemycin oxime and moxidectin; botanical insecticides such as anabasine, azadirachtin, d-limonene, nicotine, pyrethrins, cinerins, cinerin I, cinerin II, jasmolin I, jasmolin IL, pyrethrin I, pyrethrin II, quassia, rotenone, ryania and sabadilla; carbamate insecticides such as bendiocarb and carbaryl; benzofuranyl methylcarbamate insecticides such as benfuracarb, carbofuran, carbosulfan, decarbofuran and furathiocarb; dimethylcarbamate insecticides dimitan, dimetilan, hyquincarb and pirimicarb; oxime carbamate insecticides such as alanycarb, aldicarb, aldoxycarb, butocarboxim, butoxycarboxim, methomyl, nitrilacarb, oxamyl, tazimcarb, thiocarboxime, thiodicarb and thiofanox; phenyl methylcarbamate insecticides such as allyxycarb, aminocarb, bufencarb, butacarb, carbanolate, cloethocarb, dicresyl, dioxacarb, EMPC, ethiofencarb, fenethacarb, fenobucarb, isoprocarb, methiocarb, metolcarb, mexacarbate, promacyl, promecarb, propoxur, trimethacarb, XMC and xylylcarb; dinitrophenol insecticides such as dinex, dinoprop, dinosam and DNOC; fluorine insecticides such as barium hexafluorosilicate, cryolite, sodium fluoride, sodium hexafluoro silicate and sulfluramid; formamidine insecticides such as amitraz, chlordimeform, formetanate and formparanate; fumigant insecticides such as acrylonitrile, carbon disulfide, carbon tetrachloride, chloroform, chloropicrin, para-dichlorobenzene, 1,2-dichloropropane, ethyl formate, ethylene dibromide, ethylene dichloride, ethylene oxide, hydrogen cyanide, iodomethane, methyl bromide, methylchloroform, methylene chloride, naphthalene, phosphine, sulfuryl fluoride and tetrachloroethane; inorganic insecticides such as borax, calcium polysulfide, copper oleate, mercurous chloride, potassium thiocyanate and sodium thiocyanate; chitin synthesis inhibitors such as bistrifluron, buprofezin, chlorfluazuron, cyromazine, diflubenzuron, flucycloxuron, flufenoxuron, hexaflumuron, lufenuron, novaluron, noviflumuron, penfluron, teflubenzuron and triflumuron; juvenile hormone mimics such as epofenonane, fenoxycarb, hydroprene, kinoprene, methoprene, pyriproxyfen and triprene; juvenile hormones such as juvenile hormone I, juvenile hormone II and juvenile hormone III; moulting hormone agonists such as chromafenozide, halofenozide, methoxyfenozide and tebufenozide; moulting hormones such as a-ecdysone and ecdysterone; moulting inhibitors such as diofenolan; precocenes such as precocene I, precocene II and precocene III; unclassified insect growth regulators such as dicyclanil; nereistoxin analogue insecticides such as bensultap, cartap, thiocyclam and thiosultap; nicotinoid insecticides such as flonicamid; nitroguanidine insecticides such as clothianidin, dinotefuran, imidacloprid and thiamethoxam; nitromethylene insecticides such as nitenpyram and nithiazine; pyridylmethylamine insecticides such as acetamiprid, imidacloprid, nitenpyram and thiacloprid; organochlorine insecticides such as bromo-DDT, camphechlor, DDT, pp′-DDT, ethyl-DDD, HCH, gamma-HCH, lindane, methoxychlor, pentachlorophenol and TDE; cyclodiene insecticides such as aldrin, bromocyclen, chlorbicyclen, chlordane, chlordecone, dieldrin, dilor, endosulfan, endrin, HEOD, heptachlor, HHDN, isobenzan, isodrin, kelevan and mirex; organophosphate insecticides such as bromfenvinfos, chlorfenvinphos, crotoxyphos, dichlorvos, dicrotophos, dimethylvinphos, fospirate, heptenophos, methocrotophos, mevinphos, monocrotophos, naled, naftalofos, phosphamidon, propaphos, TEPP and tetrachlorvinphos; organothiophosphate insecticides such as dioxabenzofos, fosmethilan and phenthoate; aliphatic organothiophosphate insecticides such as acethion, amiton, cadusafos, chlorethoxyfos, chlormephos, demephion, demephion-O, demephion-S, demeton, demeton-O, demeton-S, demeton-methyl, demeton-O-methyl, demeton-S-methyl, demeton-S-methylsulphon, disulfoton, ethion, ethoprophos, IPSP, isothioate, malathion, methacrifos, oxydemeton-methyl, oxydeprofos, oxydisulfoton, phorate, sulfotep, terbufos and thiometon; aliphatic amide organothiophosphate insecticides such as amidithion, cyanthoate, dimethoate, ethoate-methyl, formothion, mecarbam, omethoate, prothoate, sophamide and vamidothion; oxime organothiophosphate insecticides such as chlorphoxim, phoxim and phoxim-methyl; heterocyclic organothiophosphate insecticides such as azamethiphos, coumaphos, coumithoate, dioxathion, endothion, menazon, morphothion, phosalone, pyraclofos, pyridaphenthion and quinothion; benzothiopyran organothiophosphate; insecticides such as dithicrofos and thicrofos; benzotriazine organothiophosphate insecticides such as azinphos-ethyl and azinphos-methyl; isoindole organothiophosphate insecticides such as dialifos and phosmet; isoxazole organothiophosphate insecticides such as isoxathion and zolaprofos; pyrazolopyrimidine organothiophosphate insecticides such as chlorprazophos and pyrazophos; pyridine organothiophosphate insecticides such as chlorpyrifos and chlorpyrifos-methyl; pyrimidine organothiophosphate insecticides such as butathiofos, diazinon, etrimfos, lirimfos, pirimiphos-ethyl, pirimiphos-methyl, primidophos, pyrimitate and tebupirimfos; quinoxaline organothiophosphate insecticides such as quinalphos and quinalphos-methyl; thiadiazole organothiophosphate insecticides such as athidathion, lythidathion, methidathion and prothidathion; triazole organothiophosphate insecticides such as isazofos and triazophos; phenyl organothiophosphate insecticides such as azothoate, bromophos, bromophos-ethyl, carbophenothion, chlorthiophos, cyanophos, cythioate, dicapthon, dichlofenthion, etaphos, famphur, fenchlorphos, fenitrothion, fensulfothion, fenthion, fenthion-ethyl, heterophos, jodfenphos, mesulfenfos, parathion, parathion-methyl, phenkapton, phosnichlor, profenofos, prothiofos, sulprofos, temephos, trichlormetaphos-3 and trifenofos; phosphonate insecticides such as butonate and trichlorfon; phosphonothioate insecticides such as imicyafos and mecarphon; phenyl ethylphosphonothioate insecticides such as fonofos and trichloronat; phenyl phenylphosphonothioate insecticides such as cyanofenphos, EPN and leptophos; phosphoramidate insecticides such as crufomate, fenamiphos, fosthietan, mephosfolan, phosfolan and pirimetaphos; phosphoramidothioate insecticides such as acephate, isocarbophos, isofenphos, methamidophos and propetamphos; phosphorodiamide insecticides such as dimefox, mazidox, mipafox and schradan; oxadiazine insecticides such as indoxacarb; phthalimide insecticides such as dialifos, phosmet and tetramethrin; pyrazole insecticides such as acetoprole, ethiprole, fipronil, pyrafluprole, pyriprole, tebufenpyrad, tolfenpyrad and vaniliprole; pyrethroid ester insecticides such as acrinathrin, allethrin, bioallethrin, barthrin, bifenthrin, ioethanomethrin, cyclethrin, cycloprothrin, cyfluthrin, betacyfluthrin, cyhalothrin, gamma-cyhalothrin, lambda-cyhalothrin, cypermethrin, alphacypermethrin, beta-cypermethrin, theta-cypermethrin, zeta-cypermethrin, cyphenothrin, deltamethrin, dimefluthrin, dimethrin, empenthrin, fenfluthrin, fenpirithrin, fenpropathrin, fenvalerate, esfenvalerate, flucythrinate, fluvalinate, tau-fluvalinate, furethrin, imiprothrin, metofluthrin, permethrin, biopermethrin, transpermethrin, phenothrin, prallethrin, profluthrin, pyresmethrin, resmethrin, bioresmethrin, cismethrin, tefluthrin, terallethrin, tetramethrin, tralomethrin and transfluthrin; pyrethroid ether insecticides such as etofenprox, flufenprox, halfenprox, protrifenbute and silafluofen; pyrimidinamine insecticides such as flufenerim and pyrimidifen; pyrrole insecticides such as chlorfenapyr; ryanodine receptor insecticides such as flubendiamide, chlorantraniliprole (rynaxypyr) and cyantranilipole; tetronic acid insecticides such as spirodiclofen, spiromesifen and spirotetramat; thiourea insecticides such as diafenthiuron; urea insecticides such as flucofuron and sulcofuron; sulfoximine insecticides such as sulfoxaflor and unclassified insecticides such as closantel, crotamiton, EXD, fenazaflor, fenazaquin, fenoxacrim, fenpyroximate, flubendiamide, hydramethylnon, isoprothiolane, malonoben, metaflumizone, metoxadiazone, nifluridide, pyridaben, pyridalyl, pyrifluquinazon, rafoxanide, triarathene and triazamate. Insecticides can be chosen based on water solubilities published in compendia such as The Pesticide Manual Fourteenth Edition, (ISBN 1-901396-14-2), which is incorporated herein by reference in its entirety. Future editions of The Pesticide Manual will also be useful for selecting insecticides which may benefit from being used with the polyalkoxylated alcohols as disclosed herein.

Examples of fungicides include ametoctradin, amisulbrom 2-(thiocyanatomethylthio)-benzothiazole, 2-phenylphenol, 8-hydroxyquinoline sulfate, antimycin, azaconazole, azoxystrobin, benalaxyl, benomyl, benthiavalicarb-isopropyl, benzylaminobenzene-sulfonate (BABS) salt, bicarbonates, biphenyl, bismerthiazol, bitertanol, bixafen, blasticidin-S, borax, Bordeaux mixture, boscalid, bromuconazole, bupirimate, BYF 1047, calcium polysulfide, captafol, captan, carbendazim, carboxin, carpropamid, carvone, chloroneb, chlorothalonil, chlozolinate, copper hydroxide, copper octanoate, copper oxychloride, copper sulfate, copper sulfate (tribasic), cuprous oxide, cyazofamid, cyflufenamid, cymoxanil, cyproconazole, cyprodinil, coumarin, dazomet, debacarb, diammonium ethylenebis-(dithiocarbamate), dichlofluanid, dichlorophen, diclocymet, diclomezine, dichloran, diethofencarb, difenoconazole, difenzoquat ion, diflumetorim, dimethomorph, dimoxystrobin, diniconazole, diniconazole-M, dinobuton, dinocap, meptyl dinocap, diphenylamine, dithianon, dodemorph, dodemorph acetate, dodine, dodine free base, edifenphos, enestrobin, epoxiconazole, ethaboxam, ethoxyquin, etridiazole, famoxadone, fenamidone, fenarimol, fenbuconazole, fenfuram, fenhexamid, fenoxanil, fenpiclonil, fenpropidin, fenpropimorph, fenpyrazamine, fentin, fentin acetate, fentin hydroxide, ferbam, ferimzone, fluazinam, fludioxonil, flumorph, fluopicolide, fluopyram, fluoroimide, fluoxastrobin, fluquinconazole, flusilazole, flusulfamide, flutolanil, flutriafol, fluxapyrad, folpet, formaldehyde, fosetyl, fosetyl-aluminium, uberidazole, furalaxyl, furametpyr, guazatine, guazatine acetates, GY-81, hexachlorobenzene, hexaconazole, hymexazol, imazalil, imazalil sulfate, imibenconazole, minoctadine, iminoctadine triacetate, iminoctadine tris(albesilate), ipconazole, iprobenfos, iprodione, iprovalicarb, isoprothiolane, isopyrazam, isotianil, kasugamycin, kasugamycin hydrochloride hydrate, kresoxim-methyl, mancopper, mancozeb, mandipropamid, maneb, mepanipyrim, mepronil, meptyldinocap, mercuric chloride, mercuric oxide, mercurous chloride, metalaxyl, mefenoxam, metalaxyl-M, metam, metam-ammonium, metam-potassium, metam-sodium, metconazole, methasulfocarb, methyl iodide, methyl isothiocyanate, metiram, metominostrobin, metrafenone, mildiomycin, myclobutanil, nabam, nitrothal-isopropyl, nuarimol, octhilinone, ofurace, oleic acid (fatty acids), orysastrobin, oxadixyl, oxine-copper, oxpoconazole fumarate, oxycarboxin, penflufen, pefurazoate, penconazole, pencycuron, pentachlorophenol, pentachlorophenyl laurate, penthiopyrad, phenylmercury acetate, phosphonic acid, phthalide, picoxystrobin, polyoxin B, polyoxins, polyoxorim, potassium bicarbonate, potassium hydroxyquinoline sulfate, probenazole, prochloraz, procymidone, propamocarb, propamocarb hydrochloride, propiconazole, propineb, proquinazid, prothioconazole, pyraclostrobin, pyraxostrobin, pyrazophos, pyribencarb, pyributicarb, pyrifenox, pyrimethanil, pyriofenone, pyrometostrobin, pyroquilon, quinoclamine, quinoxyfen, quintozene, Reynoutria sachalinensis extract, sedaxane, silthiofam, simeconazole, sodium 2-phenylphenoxide, sodium bicarbonate, sodium pentachlorophenoxide, spiroxamine, sulfur, SYP-Z071, SYP-048, SYP-Z048, tar oils, tebuconazole, tebufloquin, tecnazene, tetraconazole, thiabendazole, thifluzamide, thiophanate-methyl, thiram, tiadinil, tolclofos-methyl, tolylfluanid, triadimefon, triadimenol, triazolopyrimidine, triazoxide, tricyclazole, tridemorph, trifloxystrobin, triflumizole, triforine, triticonazole, validamycin, valiphenal, valifenate, vinclozolin, zineb, ziram, zoxamide, (RS)—N-(3,5-dichlorophenyl)-2-(methoxymethyl)-succinimide, 1,2-dichloropropane, 1,3-dichloro-1,1,3,3-tetrafluoroacetone hydrate, l-chloro-2,4-dinitronaphthalene, 1-chloro-2-nitropropane, 2-(2-heptadecyl-2-imidazolin-1-yl)ethanol, 2,3-dihydro-5-phenyl-1,4-dithi-ine 1,1,4,4-tetraoxide, 2-methoxyethylmercury acetate, 2-methoxyethylmercury chloride, 2-methoxyethylmercury silicate, 3-(4-chlorophenyl)-5-methylrhodanine, 4-(2-nitroprop-1-enyl)phenyl thiocyanateme: ampropylfos, anilazine, azithiram, barium polysulfide, Bayer 32394, benodanil, benquinox, bentaluron, benzamacril; benzamacril-isobutyl, benzamorf, binapacryl, buthiobate, cadmium calcium copper zinc chromate sulfate, carbamorph, CECA, chlobenthiazone, chloraniformethan, chlorfenazole, chlorquinox, climbazole, copper bis(3-phenylsalicylate), copper zinc chromate, cufraneb, cupric hydrazinium sulfate, cuprobam, cyclafuramid, cypendazole, cyprofuram, decafentin, dichlone, dichlozoline, diclobutrazol, dimethirimol, dinocton, dinosulfon, dinoterbon, dipyrithione, ditalimfos, dodicin, drazoxolon, EBP, ESBP, etaconazole, etem, ethirim, fenaminosulf, fenapanil, fenitropan, fluotrimazole, urcarbanil, furconazole, furconazole-cis, furmecyclox, furophanate, glyodine, griseofulvin, halacrinate, Hercules 3944, hexylthiofos, ICIA0858, isopamphos, isovaledione, mebenil, mecarbinzid, metazoxolon, methfuroxam, methylmercury dicyandiamide, metsulfovax, milneb, mucochloric anhydride, myclozolin, N-3,5-dichlorophenyl-succinimide, N-3-nitrophenylitaconimide, natamycin, N-ethylmercurio-4-toluenesulfonanilide, nickel bis(dimethyldithiocarbamate), OCH, phenylmercury dimethyldithiocarbamate, hosdiphen, prothiocarb; prothiocarb hydrochloride, pyracarbolid, pyridinitril, pyroxychlor, pyroxyfur, quinacetol; quinacetol sulfate, quinazamid, quinconazole, abenzazole, salicylanilide, SSF-109, sultropen, tecoram, thiadifluor, thicyofen, thiochlorfenphim, thiophanate, thioquinox, tioxymid, triamiphos, triarimol, triazbutil, trichlamide, UK-2A, derivatives of UK-2A such as, for example, (3S,6S,7R,8R)-8-benzyl-3-(3-(isobutyryloxymethoxy)-4-methoxypicolinamido)-6-methyl-4,9-dioxo-1,5-dioxonan-7-yl isobutyrate which has a CAS Registry Number of 328255-92-1 and will be referred to herein as 328255-92-1, urbacid, XRD-563, zarilamid, IK-1140, and propargyl amides. Fungicides can be chosen based on water solubilities published in compendia such as The Pesticide Manual Fourteenth Edition, ISBN 1-901396-14-2, which is incorporated herein by reference in its entirety. Future editions of The Pesticide Manual will also be useful for selecting fungicides for combination with the alkyoxylated alcohols as disclosed herein.

Examples of herbicides include amide herbicides such as allidochlor, beflubutamid, benzadox, benzipram, bromobutide, cafenstrole, CDEA, chlorthiamid, cyprazole, dimethenamid, dimethenamid-P, diphenamid, epronaz, etnipromid, fentrazamide, flupoxam, fomesafen, halosafen, isocarbamid, isoxaben, napropamide, naptalam, pethoxamid, propyzamide, quinonamid and tebutam; anilide herbicides such as chloranocryl, cisanilide, clomeprop, cypromid, diflufenican, etobenzanid, fenasulam, flufenacet, flufenican, mefenacet, mefluidide, metamifop, monalide, naproanilide, pentanochlor, picolinafen and propanil; arylalanine herbicides such as benzoylprop, flamprop and flamprop-M; chloroacetanilide herbicides such as acetochlor, alachlor, butachlor, butenachlor, delachlor, diethatyl, dimethachlor, metazachlor, metolachlor, S-metolachlor, pretilachlor, propachlor, propisochlor, prynachlor, terbuchlor, thenylchlor and xylachlor; sulfonanilide herbicides such as benzofluor, perfluidone, pyrimisulfan and profluazol; sulfonamide herbicides such as asulam, carbasulam, fenasulam and oryzalin; antibiotic herbicides such as bilanafos; benzoic acid herbicides such as chloramben, dicamba, 2,3,6-TBA and tricamba; pyrimidinyloxybenzoic acid herbicides such as bispyribac and pyriminobac; pyrimidinylthiobenzoic acid herbicides such as pyrithiobac; phthalic acid herbicides such as chlorthal; picolinic acid herbicides such as aminopyralid, clopyralid and picloram; quinolinecarboxylic acid herbicides such as quinclorac and quinmerac; arsenical herbicides such as cacodylic acid, CMA, DSMA, hexaflurate, MAA, MAMA, MSMA, potassium arsenite and sodium arsenite; benzoylcyclohexanedione herbicides such as mesotrione, sulcotrione, tefuryltrione and tembotrione; benzofuranyl alkylsulfonate herbicides such as benfuresate and ethofumesate; carbamate herbicides such as asulam, carboxazole chlorprocarb, dichlormate, fenasulam, karbutilate and terbucarb; carbanilate herbicides such as barban, BCPC, carbasulam, carbetamide, CEPC, chlorbufam, chlorpropham, CPPC, desmedipham, phenisopham, phenmedipham, phenmedipham-ethyl, propham and swep; cyclohexene oxime herbicides such as alloxydim, butroxydim, clethodim, cloproxydim, cycloxydim, profoxydim, sethoxydim, tepraloxydim and tralkoxydim; cyclopropylisoxazole herbicides such as isoxachlortole and isoxaflutole; dicarboximide herbicides such as benzfendizone, cinidon-ethyl, flumezin, flumiclorac, flumioxazin and flumipropyn; dinitroaniline herbicides such as benfluralin, butralin, dinitramine, ethalfluralin, fluchloralin, isopropalin, methalpropalin, nitralin, oryzalin, pendimethalin, prodiamine, profluralin and trifluralin; dinitrophenol herbicides such as dinofenate, dinoprop, dinosam, dinoseb, dinoterb, DNOC, etinofen and medinoterb; diphenyl ether herbicides such as ethoxyfen; nitrophenyl ether herbicides such as acifluorfen, aclonifen, bifenox, chlomethoxyfen, chlornitrofen, etnipromid, fluorodifen, fluoroglycofen, fluoronitrofen, fomesafen, furyloxyfen, halosafen, lactofen, nitrofen, nitrofluorfen and oxyfluorfen; dithiocarbamate herbicides such as dazomet and metam; halogenated aliphatic herbicides such as alorac, chloropon, dalapon, flupropanate, hexachloroacetone, iodomethane, methyl bromide, monochloroacetic acid, SMA and TCA; imidazolinone herbicides such asimazamethabenz, imazamox, imazapic, imazapyr, imazaquin and imazethapyr; nitrile herbicides such as bromobonil, bromoxynil, chloroxynil, dichlobenil, iodobonil, ioxynil and pyraclonil; organophosphorus herbicides such as amiprofos-methyl, anilofos, bensulide, bilanafos, butamifos, 2,4-DEP, DMPA, EBEP, fosamine, glufosinate, glyphosate and piperophos; phenoxy herbicides such as bromofenoxim, clomeprop, 2,4-DEB, 2,4-DEP, difenopenten, disul, erbon, etnipromid, fenteracol and trifopsime; phenoxyacetic herbicides such as 4-CPA, 2,4-D, 3,4-DA, MCPA, MCPA-thioethyl and 2,4,5-T; phenoxybutyric herbicides such as 4-CPB, 2,4-DB, 3,4-DB, MCPB and 2,4,5-TB; phenoxypropionic herbicides such as cloprop, 4-CPP, dichlorprop, dichlorprop-P, 3,4-DP, fenoprop, mecoprop and mecoprop-P; aryloxyphenoxypropionic herbicides such as chlorazifop, clodinafop, clofop, cyhalofop, diclofop, fenoxaprop, fenoxaprop-P, fenthiaprop, fluazifop, fluazifop-P, haloxyfop, haloxyfop-P, isoxapyrifop, metamifop, propaquizafop, quizalofop, quizalofop-P and trifop; phenylenediamine herbicides such as dinitramine and prodiamine; pyrazolyl herbicides such as benzofenap, pyrazolynate, pyrasulfotole, pyrazoxyfen, pyroxasulfone and topramezone; pyrazolylphenyl herbicides such as fluazolate and pyraflufen; pyridazine herbicides such as credazine, pyridafol and pyridate; pyridazinone herbicides such as brompyrazon, chloridazon, dimidazon, flufenpyr, metflurazon, norflurazon, oxapyrazon and pydanon; pyridine herbicides such as aminopyralid, cliodinate, clopyralid, dithiopyr, fluroxypyr, fluroxypyr-meptyl, haloxydine, picloram, picolinafen, pyriclor, thiazopyr and triclopyr; pyrimidinediamine herbicides such as iprymidam and tioclorim; quaternary ammonium herbicides such as cyperquat, diethamquat, difenzoquat, diquat, morfamquat and paraquat; thiocarbamate herbicides such as butylate, cycloate, di-allate, EPTC, esprocarb, ethiolate, isopolinate, methiobencarb, molinate, orbencarb, pebulate, prosulfocarb, pyributicarb, sulfallate, thiobencarb, tiocarbazil, tri-allate and vernolate; thiocarbonate herbicides such as dimexano, EXD and proxan; thiourea herbicides such as methiuron; triazine herbicides such as dipropetryn, triaziflam and trihydroxytriazine; chlorotriazine herbicides such as atrazine, chlorazine, cyanazine, cyprazine, eglinazine, ipazine, mesoprazine, procyazine, proglinazine, propazine, sebuthylazine, simazine, terbuthylazine and trietazine; methoxytriazine herbicides such as atraton, methometon, prometon, secbumeton, simeton and terbumeton; methylthiotriazine herbicides such as ametryn, aziprotryne, cyanatryn, desmetryn, dimethametryn, methoprotryne, prometryn, simetryn and terbutryn; triazinone herbicides such as ametridione, amibuzin, hexazinone, isomethiozin, metamitron and metribuzin; triazole herbicides such as amitrole, cafenstrole, epronaz and flupoxam; triazolone herbicides such as amicarbazone, bencarbazone, carfentrazone, flucarbazone, propoxycarbazone, sulfentrazone and thiencarbazone-methyl; triazolopyrimidine herbicides such as cloransulam, diclosulam, florasulam, flumetsulam, metosulam, penoxsulam and pyroxsulam; uracil herbicides such as butafenacil, bromacil, flupropacil, isocil, lenacil and terbacil; 3-phenyluracils; urea herbicides such as benzthiazuron, cumyluron, cycluron, dichloralurea, diflufenzopyr, isonoruron, isouron, methabenzthiazuron, monisouron and noruron; phenylurea herbicides such as anisuron, buturon, chlorbromuron, chloreturon, chlorotoluron, chloroxuron, daimuron, difenoxuron, dimefuron, diuron, fenuron, fluometuron, fluothiuron, isoproturon, linuron, methiuron, methyldymron, metobenzuron, metobromuron, metoxuron, monolinuron, monuron, neburon, parafluron, phenobenzuron, siduron, tetrafluron and thidiazuron; pyrimidinylsulfonylurea herbicides such as amidosulfuron, azimsulfuron, bensulfuron, chlorimuron, cyclosulfamuron, ethoxysulfuron, flazasulfuron, flucetosulfuron, flupyrsulfuron, foramsulfuron, halosulfuron, imazosulfuron, mesosulfuron, nicosulfuron, orthosulfamuron, oxasulfuron, primisulfuron, pyrazosulfuron, rimsulfuron, sulfometuron, sulfosulfuron and trifloxysulfuron; triazinylsulfonylurea herbicides such as chlorsulfuron, cinosulfuron, ethametsulfuron, iodosulfuron, metsulfuron, prosulfuron, thifensulfuron, triasulfuron, tribenuron, triflusulfuron and tritosulfuron; thiadiazolylurea herbicides such as buthiuron, ethidimuron, tebuthiuron, thiazafluron and thidiazuron; and unclassified herbicides such as acrolein, allyl alcohol, azafenidin, benazolin, bentazone, benzobicyclon, buthidazole, calcium cyanamide, cambendichlor, chlorfenac, chlorfenprop, chlorflurazole, chlorflurenol, cinmethylin, clomazone, CPMF, cresol, ortho-dichlorobenzene, dimepiperate, endothal, fluoromidine, fluridone, flurochloridone, flurtamone, fluthiacet, indanofan, methazole, methyl isothiocyanate, nipyraclofen, OCH, oxadiargyl, oxadiazon, oxaziclomefone, pentachlorophenol, pentoxazone, phenylmercury acetate, pinoxaden, prosulfalin, pyribenzoxim, pyriftalid, quinoclamine, rhodethanil, sulglycapin, thidiazimin, tridiphane, trimeturon, tripropindan and tritac. Herbicides can be chosen based on water solubilities publishedin compendia such as The Pesticide Manual Fourteenth Edition, ISBN 1-901396-14-2, which is incorporated herein by reference in its entirety. Future editions of The Pesticide Manual will also be useful for selecting herbicides for combination with the alkyoxylated alcohols.

Examples of modifiers of plant physiology or structure include ancymidol, aminoethoxyvinylglycine, 6-benzylaminopurine, carvone, chlorflurenol-methyl, chlormequat chloride, cloxyfonac, 4-CPA, cyclanilide, cytokinins, daminozide, dikegulac, ethephon, flurenol, flurprimidol, forchlorfenuron, gibberellic acids, gibberellins, inabenfide, indol-3-ylacetic acid, 4-indol-3ylbutyric acid, maleic hydrazide, mepiquat chloride, 1-methylcyclopropene, 2-(l-napthyl)acetamide, 1-napthylacetic acid, 2-napthyloxyacetic acid, nitrophenolates, paclobutrazol, Nphenylphthalamic acid, prohexadione-calcium, n-propyl dihydrojasmonate, thidiazuron, tribufos, trinexepac-ethyl, and uniconazole. Modifiers can be chosen based on water solubilities published in compendia such as The Pesticide Manual Fourteenth Edition, ISBN 1-901396-14-2, which is incorporated herein by reference in its entirety. Future editions of The Pesticide Manual will also be useful for selecting modifiers of plant physiology or structure for combination with alkoxylated alcohols.

Examples of herbicide safeners, include safeners such as benoxacor, benthiocarb, brassinolide, cloquintocet (mexyl), cyometrinil, cyprosulfamide, daimuron, dichlormid, dicyclonon, dimepiperate, disulfoton, fenchlorazole-ethyl, fenclorim, flurazole, fluxofenim, furilazole, isoxadifen-ethyl, mefenpyr-diethyl, MG 191, MON 4660, naphthalic anhydride (NA), oxabetrinil, R29148 and N-phenylsulfonylbenzoic acid amides.

Other potential ingredients in a pesticide or herbicide formulation may be may be inactive or inert ingredients such as dispersants, thickening agents, stickers, film-forming agents, buffers, emulsifiers, anti-freezing agents, dyes, stabilizers, solid carriers and the like may. Those additional ingredients individually and cumulatively can be present in amounts of from 0, or from 0.1 or from 0.5 up to 10, up to 8, up to 5, up to 3, up to 2, or up to 1 weight percent based on total weight of the composition.

### EXAMPLES

### Synthesis of Polyalkoxylated Alcohols.

The alkoxylation reactions were conducted in two stages in a Parallel Pressure Reactor (PPR) setup containing 48 small reactor cells (6 modules each having 8 cells) with glass inserts and equipped with removable poly(ether ether ketone) (PEEK) paddles for mechanical stirring.

In the first stage the intermediates A-H of the type R—O—(BO)m-H as listed in Table 1 were prepared in triplicate each using three modules, i.e. in total 24 cells of the PPR setup, by butoxylation of the corresponding precursor alcohols R—OH. For each cell, a glass insert and a removable PEEK stir paddle were dried in a vacuum oven at 125° C. overnight. Starting solutions were prepared from the precursor alcohols R—OH (A, B: 1-dodecanol, 98+% (A.C.S. reagent); C, D: 2-ethyl-1-hexanol, 99.6%; E: farnesol, 95% (mixture of isomers); F: nerol, 97%; G: cinnamyl alcohol, 98%; H: (1R)-(−)-myrtenol (also referred to as myrtenyl alcohol), 95%; all purchased from Sigma-Aldrich) each by dissolving therein potassium in an amount of about 1 wt. % based on the weight of the alcohol. Herein, 1-dodecanol and cinnamyl alcohol were heated to a temperature slightly above their respective melting point (22-26° C. or 33-35° C., respectively) to keep them in a liquid state. An aliquot of the respective starter solution corresponding to a targeted amount of 6-10 millimoles (mmol) of the alcohol was each charged manually using a pipette into the glass insert for the respective reaction cell under nitrogen and the mass of the starting material in each insert was recorded. Then the corresponding 24 reactor cells were each charged manually with the calculated amount of 1,2-butylene oxide (99+%, purchased from Sigma-Aldrich) corresponding to the targeted length of the (BO)m block assuming complete consumption of the butylene oxide in the butoxylation reaction of the precursor alcohols. The glass inserts were loaded into the corresponding PPR wells and the stirring paddles attached. Subsequently, the reactor cells were sealed, heated to 120° C. and the reaction mixtures were stirred for 20 hours at this temperature. The reactor was then cooled and the cells were vented and purged with nitrogen to remove residual butylene oxide. The glass inserts were then removed from the reactors, and the resulting material obtained from the triplicate runs for each targeted type of intermediate as listed in Table 1 was combined. Thus eight samples corresponding to intermediates A-H were obtained. A portion of each of these samples was set aside for molecular weight analysis of the intermediates as set forth below.

The remaining amounts of the prepared intermediates were used as starting material for ethoxylation in the second stage of the preparation process to synthesize the 24 targeted polyalkoxylated alcohols A1 to H3 as listed in Table 1. Each of the polyalkoxylated alcohols of Table 1 was synthesized in duplicate, i.e. a set of samples corresponding to targeted compounds A1 to H3 was prepared in modules 1-3 and a second set of samples (not shown) having the same targeted compositions was prepared in modules 4-6 of the PPR setup. Accordingly the remaining amount of each of the eight R—O—(BO)m-H intermediates prepared in the first stage was divided in six parts of comparable mass that were placed into six glass inserts to give a total of 48 filled glass inserts. The mass of material in each insert was recorded. The inserts were then loaded into the designated PPR wells, and the stirring paddles were attached. Subsequently, the reactor cells were sealed, heated to 60° C., and pressurized with nitrogen to a pressure of 345 kPa (50 psi). Ethylene oxide (99.99%) purchased from ARC Specialty Products was then delivered to each of the 48 cells via an Isco syringe pump equipped with a robotically controlled needle and compressed gas microvalve connected to the Symyx PPR setup. The amount of added ethylene oxide was each calculated to correspond to the desired length of the (EO)n block of the respective targeted final polyalkoxylated alcohol as listed in Table 1 assuming almost complete consumption of the ethylene oxide in the ethoxylation reaction of the intermediates. After the addition of ethylene oxide, the temperature was increased to 140° C. and the reaction mixtures were stirred for 4 hours at this temperature. After cooling and venting as described above for the first stage, the mass of each glass inset with the resulting product was measured to determine the effectively added amount of ethylene oxide each. The resulting samples of polyalkoxylated alcohols R—O—(BO)m-(EO)n-H were used without further purification for molecular weight analysis and the preparation of pharmaceutical compositions as set forth below.

### Molecular Weight Determination

The molecular weight distributions of the prepared intermediates R—O—(BO)m-H were determined by accurate mass liquid chromatography/electrospray ionization-mass spectrometry (LC/ESI-MS) in the positive ion (PI) mode. For this purpose the as-prepared intermediates were each dissolved in methanol THF in an amount of 3 2 mg/mL. 2 μL aliquots of these solutions were injected to a Waters Alliance 2795 ternary gradient Agilent 1200 high performance liquid chromatograph (HPLC) coupled to an Agilent 6520 QTOF mass spectrometer. Micromass LCT_premier, SN #KD-184, time of flight MS system via a Micromass Z-spray electrospray (ESI) interface operating in the PI mode. The following analysis conditions were used:

Column: Phenomenex Kinetax C18 (2.8 μm, 3×150 mm), mobil phase (A) 0.1% formic acid in water; (B) THF. None Flow Injection Mobile phase: 0.03 M ammonium acetate in methanol Flow rate: 1.00.75, injection volume 2.0 μL, column temperature (° C.): 40, wavelength 210-600 nm. mL/min (split 2:1) ESI conditions: Source Block: 110° C.; Desolvation: 250° C.; Capillary: 2.5 kV; Cone: 100V MS conditions: MCP: 2,300V; Mode: +TOFMS; Continuum; Resolution 10,000 (+) Scan: 50 to 2,800 amu (+); Rate: 1.0 sec/scan Lock Spray: −10 μL/min of (556.2713 amu (+))-(YGGFL).

As the detected ions were adducts of the respective intermediate with an ammonium ion, the experimental molecular weight data were corrected by subtracting the molecular weight of the ammonium ion, M(NH4+): 18 amu, to yield values representative for the intermediate itself. Table 1 shows the number average molecular weight (Mn), the weight average molecular weight (Mw) and the polydispersity index (Mw/Mn) calculated accordingly from the obtained experimental molecular weight distributions for the prepared intermediates. Table 1 further comprises the average number of BO units per molecule, m, for each prepared intermediate, which were calculated by subtracting the molecular weight of the respective precursor alcohol, M(R—OH), from Mn of the intermediate. Mass spectra were subjected to an external calibration to generate accurate mass information within +/−3 mDa. Following the external calibration, accurate mass prediction software was utilized to generate empirical formulae for MS and fragment ions. Utilizing both the predicted empirical formula and the dissociation behavior of each parent ion, proposed structures for each component have been provided.

### Molecular Weight Determination for the Final Polymers was Determined by GPC

GPC samples were prepared by weighing ˜10 mg of each sample into pre-weighted vials, and the accurate weights were then determined. THF was added to prepare 1.0 mg/mL solutions. Samples were shaken to dissolve solids and filtered using Acrodisc® CR 13 mm Syringe Filter with 0.2 μm RTFE membrane into vials for GPC analysis. Analysis was performed on an Agilent 1260 Infinity equipped with 1 PLgel 3 μm×50 mm×7.5 mm Guard column and 2 PLgel 3 μm×50 mm×7.5 m Mixed E columns maintained at 35° C. The samples were eluted with THF at a flowrate of 1.77 mL/min and using the refractive index detector (RID). The molecular weight calibration curve was created using Agilent PS-1 and PS-2 polystyrene standards, excluding points with molecular weights above 50,000.

TABLE 1

| | Alcohol | | | | | | | | | |
|---|---|---|---|---|---|---|---|---|---|---|
| Sample | Initiator | Target | Target | Mn | Mw | Mw/ | Actual | Actual | m + n | m/n |
| # | (Ax) | m | n | (g/mol) | (g/mol) | Mn | m | n | (actual) | (Actual) |
| A1 | Dodecanol | 4 | 16 | 1439 | 1721 | 1.20 | 4.5 | 14.7 | 19.2 | 0.31 |
| A2 | Dodecanol | 4 | 24 | 1811 | 2177 | 1.20 | 4.5 | 18.4 | 22.9 | 0.24 |
| A3 | Dodecanol | 4 | 30 | 2002 | 2429 | 1.21 | 4.5 | 20.1 | 24.6 | 0.22 |
| A4 | Dodecanol | 8 | 16 | 1828 | 2152 | 1.18 | 7.6 | 13.2 | 20.8 | 0.58 |
| A5 | Dodecanol | 8 | 24 | 2389 | 2905 | 1.22 | 7.6 | 18.7 | 26.3 | 0.41 |
| A6 | Dodecanol | 8 | 30 | 2616 | 3214 | 1.23 | 7.6 | 20.7 | 28.3 | 0.37 |
| B1 | 2- | 4 | 16 | 1432 | 1669 | 1.17 | 5.2 | 15.9 | 21.1 | 0.33 |
| | Ethylhexanol | | | | | | | | | |
| B2 | 2- | 4 | 24 | 1704 | 2091 | 1.23 | 5.2 | 22.9 | 28.1 | 0.23 |
| | Ethylhexanol | | | | | | | | | |
| B3 | 2- | 4 | 30 | 2326 | 2759 | 1.19 | 5.2 | 32.8 | 38 | 0.16 |
| | Ethylhexanol | | | | | | | | | |
| B4 | 2- | 8 | 16 | 1669 | 2005 | 1.20 | 8.1 | 14.1 | 22.2 | 0.57 |
| | Ethylhexanol | | | | | | | | | |
| B5 | 2- | 8 | 24 | 2098 | 2529 | 1.21 | 8.1 | 17.3 | 25.4 | 0.47 |
| | Ethylhexanol | | | | | | | | | |
| B6 | 2- | 8 | 30 | 2021 | 2455 | 1.21 | 8.1 | 19.1 | 27.2 | 0.42 |
| | Ethylhexanol | | | | | | | | | |
| C1 | Farnesol | 4 | 16 | 1334 | 1659 | 1.24 | 4.9 | 14.4 | 19.3 | 0.34 |
| C2 | Farnesol | 4 | 24 | 1521 | 1753 | 1.15 | 4.9 | 22.5 | 27.4 | 0.22 |
| C3 | Farnesol | 4 | 30 | 1365 | 1553 | 1.14 | 4.9 | 16.4 | 21.3 | 0.30 |
| C4 | Farnesol | 8 | 16 | 1424 | 1801 | 1.26 | 6.8 | 12.8 | 19.6 | 0.53 |
| C5 | Farnesol | 8 | 24 | 1742 | 2193 | 1.26 | 6.8 | 17.7 | 24.5 | 0.38 |
| C6 | Farnesol | 8 | 30 | 1894 | 2187 | 1.15 | 6.8 | 21.9 | 28.7 | 0.31 |
| D1 | Nerol | 4 | 16 | 897 | 1584 | 1.77 | 5.3 | 17.9 | 23.2 | 0.30 |
| D2 | Nerol | 4 | 24 | 1606 | 1861 | 1.16 | 5.3 | 18.2 | 23.5 | 0.29 |
| D3 | Nerol | 4 | 30 | 3668 | 4191 | 1.14 | 5.3 | 35.5 | 40.8 | 0.15 |
| D4 | Nerol | 8 | 16 | 1437 | 2072 | 1.44 | 7.8 | 15.1 | 22.9 | 0.52 |
| D5 | Nerol | 8 | 24 | 2057 | 2651 | 1.29 | 7.8 | 20.5 | 28.3 | 0.38 |
| D6 | Nerol | 8 | 30 | 2080 | 2484 | 1.19 | 7.8 | 21.9 | 29.7 | 0.36 |
| E1 | Cinnamyl | 4 | 16 | 1291 | 1544 | 1.20 | 4.6 | 15.5 | 20.1 | 0.30 |
| | Alcohol | | | | | | | | | |
| E2 | Cinnamyl | 4 | 24 | 1454 | 1785 | 1.23 | 4.6 | 20.3 | 24.9 | 0.23 |
| | Alcohol | | | | | | | | | |
| E3 | Cinnamyl | 4 | 30 | 1232 | 1804 | 1.46 | 4.6 | 23.9 | 28.5 | 0.19 |
| | Alcohol | | | | | | | | | |
| E4 | Cinnamyl | 8 | 16 | 1471 | 1949 | 1.32 | 6.6 | 18 | 24.6 | 0.37 |
| | Alcohol | | | | | | | | | |
| E5 | Cinnamyl | 8 | 24 | 1535 | 2025 | 1.32 | 6.6 | 15.8 | 22.4 | 0.42 |
| | Alcohol | | | | | | | | | |
| E6 | Cinnamyl | 8 | 30 | 1641 | 2176 | 1.33 | 6.6 | 17.8 | 24.4 | 0.37 |
| | Alcohol | | | | | | | | | |
| F1 | Myrtenol | 4 | 16 | 1353 | 1629 | 1.20 | 5.3 | 15.4 | 20.7 | 0.34 |
| F2 | Myrtenol | 4 | 24 | 2031 | 2591 | 1.28 | 5.3 | 15.1 | 20.4 | 0.35 |
| F3 | Myrtenol | 4 | 30 | 2056 | 2551 | 1.24 | 5.3 | 15.6 | 20.9 | 0.34 |
| F4 | Myrtenol | 8 | 16 | 1686 | 2109 | 1.25 | 8.2 | 15.2 | 23.4 | 0.54 |
| F5 | Myrtenol | 8 | 24 | 1982 | 2601 | 1.31 | 8.2 | 15.9 | 24.1 | 0.52 |
| F6 | Myrtenol | 8 | 30 | 2423 | 3020 | 1.25 | 8.2 | 19.5 | 27.7 | 0.42 |

### Examples 1-144

The synthesized polyalkoxylated alcohols from Table 1 were evaluated as solubility enhancement additives in mixtures with two different agricultural actives: difenoconazole (water solubility<15 mg/L at 20° C.) and pyraclostrobin (water solubility<1.9 mg/L at 20° C.). Concentrated liquid mixtures of were prepared by hand dissolving 1 wt % active into a water miscible solvent, namely methanol. The polyalkoxylated alcohol is added to the active/solvent mixture at the mass ratio specified in Table 2. An aliquot of the active/solvent/polyalkoxylated alcohol mixture is then diluted into deionized water to make a 500 ppm active solution. Immediately, the samples are capped and transferred to a Turbiscan instrument to measure turbidity for a 20 hour period.

Table 2 contains a summary of the transmission data (% T) and the corresponding visual observation collected from the Turbiscan. The transmission data is averaged over the height of the sample from the vial bottom to the meniscus at each time interval (0 hour (hr), 1 hr, 2 hr, 4 hr, 8 hr, 12 hr, 16 hr, and 20 hr). The transmission data has been normalized using the average transmission of the polymer only controls (76%) at a polymer concentration equivalent to 10:1 polymer:active which is 5000 ppm. The polymer only controls were visually clear over the 20 hour test.

The visual observations are reported at time equal to 0 hr and 24 hr. These qualitative descriptors are in order from most transparent to most turbid as follows with the following definitions:

Clear—Complete transparency, no observable turbidity

Slightly Hazy—Observed to be between Clear and Hazy

Hazy—Observable turbidity, but light still passes through the sample

Slightly Cloudy—Observed to be between Hazy and Cloudy

Cloudy—Complete opacity, no light passing through the sample

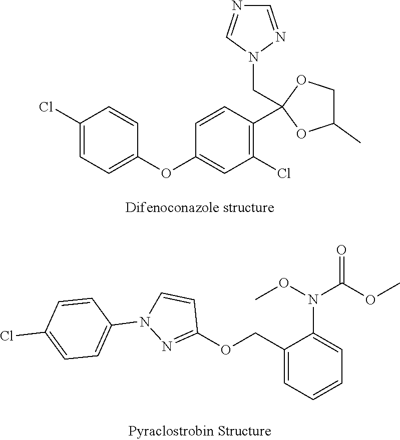 [SMILES: CC1COC(Cn2cncn2)(c2ccc(Oc3ccc(Cl)cc3)cc2Cl)O1 ; COC(=O)N(OC)c1ccccc1COc1ccn(-c2ccc(Cl)cc2)n1]

### Comparative Examples 1-3, CE1-3

Following the preparation and characterization procedure described in examples 1-144, samples of active only were prepared at 500 ppm in deionized water, and analyzed using the Turbiscan. Table 2 shows the transmission summary and visual observations from these samples. The clearing of the sample and increase in percent transmission is due to the sedimentation of the active causes by the gross failure of the samples.

TABLE 2

| | | | | | | | | | | | | t = | t = |
|---|---|---|---|---|---|---|---|---|---|---|---|---|---|
| | Polyalkoxylated | | Polyalkoxylated | t = | t = | t = | t = | t = | t = | t = | t = | 0 hr | 24 hr |
| Sample # | Alcohol | | Alcohol:Active | 0 hr | 1 hr | 2 hr | 4 hr | 8 hr | 12 hr | 16 hr | 20 hr | (visual) | (visual) |
| units | Sample # | Active | Mass Ratio | % T | % T | % T | % T | % T | % T | % T | % T | — | — |
| 1 | A1 | Difenoconazole | 3 | 94 | 95 | 95 | 94 | 96 | 96 | 96 | 93 | Clear | Slightly |
| | | | | | | | | | | | | | Hazy |
| 2 | A2 | Difenoconazole | 3 | 94 | 92 | 91 | 90 | 88 | 87 | 86 | 85 | Clear | Slightly |
| | | | | | | | | | | | | | Cloudy |
| 3 | A3 | Difenoconazole | 3 | 84 | 85 | 84 | 84 | 86 | 86 | 86 | 84 | Slightly | Slightly |
| | | | | | | | | | | | | Cloudy | Cloudy |
| 4 | A4 | Difenoconazole | 3 | 92 | 91 | 91 | 91 | 92 | 92 | 92 | 90 | Clear | Slightly |
| | | | | | | | | | | | | | Cloudy |
| 5 | A5 | Difenoconazole | 3 | 82 | 83 | 83 | 82 | 84 | 83 | 83 | 81 | Slightly | Slightly |
| | | | | | | | | | | | | Cloudy | Cloudy |
| 6 | A6 | Difenoconazole | 3 | 93 | 94 | 94 | 93 | 96 | 96 | 96 | 93 | Clear | Slightly |
| | | | | | | | | | | | | | Hazy |
| 7 | B1 | Difenoconazole | 3 | 95 | 93 | 91 | 91 | 89 | 85 | 83 | 79 | Clear | Hazy |
| 8 | B2 | Difenoconazole | 3 | 91 | 71 | 62 | 61 | 51 | 44 | 40 | 35 | Clear | Cloudy |
| 9 | B3 | Difenoconazole | 3 | 93 | 90 | 90 | 92 | 94 | 95 | 95 | 93 | Clear | Slightly |
| | | | | | | | | | | | | | Hazy |
| 10 | B4 | Difenoconazole | 3 | 91 | 81 | 82 | 88 | 87 | 86 | 85 | 83 | Clear | Hazy |
| 11 | B5 | Difenoconazole | 3 | 74 | 64 | 64 | 69 | 70 | 69 | 68 | 67 | Cloudy | Slightly |
| | | | | | | | | | | | | | Cloudy |
| 12 | B6 | Difenoconazole | 3 | 77 | 67 | 66 | 65 | 55 | 48 | 43 | 38 | Cloudy | Cloudy |
| 13 | C1 | Difenoconazole | 3 | 96 | 94 | 92 | 88 | 84 | 80 | 76 | 71 | Clear | Cloudy |
| 14 | C2 | Difenoconazole | 3 | 68 | 33 | 22 | 12 | 7 | 7 | 9 | 11 | Cloudy | Cloudy |
| 15 | C3 | Difenoconazole | 3 | 95 | 95 | 95 | 95 | 96 | 96 | 96 | 95 | Clear | Slightly |
| | | | | | | | | | | | | | Hazy |
| 16 | C4 | Difenoconazole | 3 | 58 | 24 | 16 | 9 | 5 | 4 | 4 | 6 | Cloudy | Cloudy |
| 17 | C5 | Difenoconazole | 3 | 86 | 81 | 78 | 75 | 71 | 69 | 67 | 66 | Slightly | Cloudy |
| | | | | | | | | | | | | Cloudy | |
| 18 | C6 | Difenoconazole | 3 | 68 | 53 | 47 | 39 | 30 | 25 | 21 | 18 | Cloudy | Cloudy |
| 19 | D1 | Difenoconazole | 3 | 101 | 101 | 101 | 101 | 101 | 101 | 101 | 101 | Clear | Clear |
| 20 | D2 | Difenoconazole | 3 | 99 | 100 | 100 | 100 | 100 | 100 | 100 | 100 | Clear | Clear |
| 21 | D3 | Difenoconazole | 3 | 73 | 73 | 74 | 73 | 73 | 72 | 72 | 72 | Cloudy | Cloudy |
| 22 | D4 | Difenoconazole | 3 | 96 | 92 | 93 | 93 | 92 | 92 | 92 | 92 | Clear | Clear |
| 23 | D5 | Difenoconazole | 3 | 93 | 94 | 94 | 94 | 94 | 94 | 94 | 94 | Clear | Clear |
| 24 | D6 | Difenoconazole | 3 | 100 | 100 | 100 | 100 | 100 | 100 | 100 | 100 | Clear | Clear |
| 25 | E1 | Difenoconazole | 3 | 98 | 99 | 99 | 99 | 101 | 101 | 101 | 99 | Clear | Clear |
| 26 | E2 | Difenoconazole | 3 | 96 | 96 | 96 | 96 | 98 | 98 | 98 | 96 | Clear | Clear |
| 27 | E3 | Difenoconazole | 3 | 97 | 97 | 97 | 97 | 99 | 99 | 99 | 97 | Clear | Clear |
| 28 | E4 | Difenoconazole | 3 | 93 | 93 | 93 | 93 | 94 | 94 | 94 | 93 | Clear | Clear |
| 29 | E5 | Difenoconazole | 3 | 88 | 92 | 92 | 92 | 94 | 94 | 94 | 92 | Slightly | Clear |
| | | | | | | | | | | | | Hazy | |
| 30 | E6 | Difenoconazole | 3 | 100 | 100 | 100 | 100 | 98 | 98 | 98 | 100 | Clear | Clear |
| 31 | F1 | Difenoconazole | 3 | 95 | 94 | 95 | 94 | 94 | 93 | 93 | 91 | Clear | Slightly |
| | | | | | | | | | | | | | Hazy |
| 32 | F2 | Difenoconazole | 3 | 96 | 97 | 97 | 97 | 99 | 99 | 99 | 97 | Clear | Clear |
| 33 | F3 | Difenoconazole | 3 | 95 | 95 | 95 | 95 | 97 | 97 | 97 | 95 | Clear | Slightly |
| | | | | | | | | | | | | | Hazy |
| 34 | F4 | Difenoconazole | 3 | 95 | 95 | 95 | 95 | 97 | 97 | 97 | 95 | Clear | Clear |
| 35 | F5 | Difenoconazole | 3 | 92 | 92 | 92 | 92 | 94 | 94 | 94 | 92 | Clear | Clear |
| 36 | F6 | Difenoconazole | 3 | 94 | 95 | 95 | 95 | 97 | 98 | 98 | 95 | Clear | Clear |
| 37 | A1 | Difenoconazole | 10 | 100 | 100 | 100 | 100 | 100 | 100 | 100 | 100 | Clear | Clear |
| 38 | A2 | Difenoconazole | 10 | 100 | 100 | 100 | 100 | 100 | 100 | 100 | 100 | Clear | Clear |
| 39 | A3 | Difenoconazole | 10 | 98 | 98 | 98 | 98 | 98 | 98 | 98 | 98 | Clear | Hazy |
| 40 | A4 | Difenoconazole | 10 | 94 | 97 | 96 | 97 | 96 | 96 | 96 | 96 | Clear | Hazy |
| 41 | A5 | Difenoconazole | 10 | 94 | 96 | 96 | 96 | 96 | 96 | 96 | 96 | Clear | Clear |
| 42 | A6 | Difenoconazole | 10 | 98 | 98 | 98 | 99 | 97 | 97 | 97 | 98 | Clear | Clear |
| 43 | B1 | Difenoconazole | 10 | 98 | 99 | 100 | 100 | 99 | 99 | 99 | 100 | Clear | Clear |
| 44 | B2 | Difenoconazole | 10 | 99 | 100 | 100 | 100 | 100 | 100 | 100 | 100 | Clear | Clear |
| 45 | B3 | Difenoconazole | 10 | 97 | 98 | 100 | 100 | 100 | 100 | 100 | 100 | Clear | Clear |
| 46 | B4 | Difenoconazole | 10 | 98 | 99 | 99 | 99 | 98 | 98 | 98 | 99 | Clear | Clear |
| 47 | B5 | Difenoconazole | 10 | 90 | 92 | 92 | 93 | 92 | 92 | 92 | 93 | Hazy | Clear |
| 48 | B6 | Difenoconazole | 10 | 95 | 97 | 98 | 98 | 98 | 98 | 98 | 98 | Clear | Clear |
| 49 | C1 | Difenoconazole | 10 | 99 | 100 | 100 | 100 | 100 | 100 | 100 | 100 | Clear | Clear |
| 50 | C2 | Difenoconazole | 10 | 98 | 99 | 100 | 99 | 99 | 99 | 99 | 100 | Clear | Clear |
| 51 | C3 | Difenoconazole | 10 | 99 | 100 | 101 | 101 | 100 | 100 | 100 | 101 | Clear | Slightly |
| | | | | | | | | | | | | | Hazy |
| 52 | C4 | Difenoconazole | 10 | 60 | 39 | 34 | 29 | 23 | 21 | 20 | 20 | Cloudy | Cloudy |
| 53 | C5 | Difenoconazole | 10 | 92 | 94 | 94 | 94 | 94 | 94 | 94 | 94 | Hazy | Clear |
| 54 | C6 | Difenoconazole | 10 | 95 | 96 | 96 | 97 | 97 | 97 | 97 | 97 | Clear | Clear |
| 55 | D1 | Difenoconazole | 10 | 99 | 99 | 99 | 100 | 99 | 99 | 99 | 100 | Clear | Clear |
| 56 | D2 | Difenoconazole | 10 | 100 | 101 | 101 | 101 | 101 | 101 | 101 | 101 | Clear | Clear |
| 57 | D3 | Difenoconazole | 10 | 94 | 94 | 94 | 94 | 94 | 94 | 94 | 94 | Clear | Slightly |
| | | | | | | | | | | | | | Hazy |
| 58 | D4 | Difenoconazole | 10 | 98 | 98 | 98 | 98 | 97 | 97 | 97 | 97 | Clear | Slightly |
| | | | | | | | | | | | | | Hazy |
| 59 | D5 | Difenoconazole | 10 | 99 | 100 | 100 | 100 | 100 | 100 | 100 | 100 | Clear | Clear |
| 60 | D6 | Difenoconazole | 10 | 93 | 94 | 94 | 94 | 94 | 94 | 94 | 94 | Clear | Clear |
| 61 | E1 | Difenoconazole | 10 | 99 | 99 | 99 | 99 | 100 | 100 | 100 | 100 | Clear | Clear |
| 62 | E2 | Difenoconazole | 10 | 98 | 98 | 99 | 99 | 98 | 98 | 98 | 99 | Clear | Clear |
| 63 | E3 | Difenoconazole | 10 | 100 | 101 | 101 | 101 | 100 | 100 | 100 | 101 | Clear | Clear |
| 64 | E4 | Difenoconazole | 10 | 98 | 98 | 98 | 98 | 98 | 98 | 98 | 98 | Clear | Clear |
| 65 | E5 | Difenoconazole | 10 | 94 | 94 | 94 | 94 | 94 | 94 | 94 | 94 | Clear | Clear |
| 66 | E6 | Difenoconazole | 10 | 99 | 99 | 99 | 99 | 99 | 99 | 99 | 99 | Clear | Clear |
| 67 | F1 | Difenoconazole | 10 | 100 | 100 | 100 | 100 | 100 | 100 | 100 | 101 | Clear | Clear |
| 68 | F2 | Difenoconazole | 10 | 100 | 100 | 100 | 100 | 100 | 100 | 100 | 100 | Clear | Clear |
| 69 | F3 | Difenoconazole | 10 | 100 | 101 | 101 | 101 | 100 | 100 | 100 | 101 | Clear | Clear |
| 70 | F4 | Difenoconazole | 10 | 100 | 100 | 100 | 100 | 100 | 100 | 100 | 100 | Clear | Clear |
| 71 | F5 | Difenoconazole | 10 | 98 | 99 | 99 | 99 | 98 | 98 | 98 | 99 | Clear | Clear |
| 72 | F6 | Difenoconazole | 10 | 96 | 97 | 97 | 97 | 96 | 96 | 96 | 97 | Clear | Clear |
| 73 | A1 | Pyraclostrobin | 3 | 89 | 76 | 69 | 59 | 46 | 38 | 0 | 0 | Cloudy | Cloudy |
| 74 | A2 | Pyraclostrobin | 3 | 71 | 47 | 36 | 26 | 17 | 12 | 0 | 0 | Cloudy | Cloudy |
| 75 | A3 | Pyraclostrobin | 3 | 58 | 54 | 53 | 51 | 49 | 49 | 0 | 0 | Cloudy | Cloudy |
| 76 | A4 | Pyraclostrobin | 3 | 59 | 48 | 42 | 37 | 32 | 29 | 0 | 0 | Cloudy | Cloudy |
| 77 | A5 | Pyraclostrobin | 3 | 50 | 36 | 31 | 26 | 22 | 19 | 0 | 0 | Cloudy | Cloudy |
| 78 | A6 | Pyraclostrobin | 3 | 70 | 64 | 61 | 57 | 51 | 47 | 0 | 0 | Cloudy | Cloudy |
| 79 | B1 | Pyraclostrobin | 3 | 49 | 29 | 20 | 12 | 7 | 5 | 4 | 4 | Cloudy | Cloudy |
| 80 | B2 | Pyraclostrobin | 3 | 33 | 12 | 7 | 3 | 1 | 1 | 1 | 2 | Cloudy | Cloudy |
| 81 | B3 | Pyraclostrobin | 3 | 60 | 57 | 56 | 55 | 57 | 59 | 60 | 61 | Cloudy | Cloudy |
| 82 | B4 | Pyraclostrobin | 3 | 53 | 39 | 32 | 25 | 18 | 14 | 11 | 9 | Cloudy | Cloudy |
| 83 | B5 | Pyraclostrobin | 3 | 35 | 23 | 19 | 14 | 10 | 8 | 7 | 6 | Cloudy | Cloudy |
| 84 | B6 | Pyraclostrobin | 3 | 32 | 18 | 13 | 9 | 5 | 4 | 3 | 3 | Cloudy | Cloudy |
| 85 | C1 | Pyraclostrobin | 3 | 68 | 40 | 30 | 20 | 12 | 8 | 6 | 5 | Cloudy | Cloudy |
| 86 | C2 | Pyraclostrobin | 3 | 46 | 9 | 4 | 1 | 1 | 2 | 4 | 7 | Cloudy | Cloudy |
| 87 | C3 | Pyraclostrobin | 3 | 78 | 76 | 75 | 74 | 72 | 71 | 71 | 70 | Cloudy | Cloudy |
| 88 | C4 | Pyraclostrobin | 3 | 36 | 8 | 4 | 2 | 1 | 2 | 4 | 6 | Cloudy | Cloudy |
| 89 | C5 | Pyraclostrobin | 3 | 61 | 39 | 31 | 23 | 17 | 13 | 11 | 10 | Cloudy | Cloudy |
| 90 | C6 | Pyraclostrobin | 3 | 52 | 22 | 17 | 11 | 7 | 5 | 4 | 4 | Cloudy | Cloudy |
| 91 | D1 | Pyraclostrobin | 3 | 75 | 71 | 72 | 73 | 74 | 75 | 75 | 75 | Cloudy | Hazy |
| 92 | D2 | Pyraclostrobin | 3 | 92 | 92 | 92 | 91 | 90 | 89 | 89 | 88 | Slightly | Hazy |
| | | | | | | | | | | | | Hazy | |
| 93 | D3 | Pyraclostrobin | 3 | 77 | 77 | 76 | 76 | 75 | 74 | 74 | 74 | Cloudy | Hazy |
| 94 | D4 | Pyraclostrobin | 3 | 93 | 93 | 93 | 92 | 92 | 92 | 91 | 91 | Clear | Hazy |
| 95 | D5 | Pyraclostrobin | 3 | 92 | 91 | 90 | 88 | 85 | 83 | 81 | 79 | Slightly | Hazy |
| | | | | | | | | | | | | Hazy | |
| 96 | D6 | Pyraclostrobin | 3 | 95 | 95 | 94 | 94 | 93 | 92 | 92 | 91 | Clear | Hazy |
| 97 | E1 | Pyraclostrobin | 3 | 54 | 52 | 51 | 50 | 49 | 48 | 47 | 46 | Cloudy | Cloudy |
| 98 | E2 | Pyraclostrobin | 3 | 82 | 78 | 75 | 72 | 68 | 64 | 62 | 60 | Cloudy | Cloudy |
| 99 | E3 | Pyraclostrobin | 3 | 86 | 85 | 85 | 84 | 84 | 83 | 83 | 83 | Hazy | Hazy |
| 100 | E4 | Pyraclostrobin | 3 | 91 | 90 | 88 | 86 | 82 | 79 | 77 | 75 | Slightly | Cloudy |
| | | | | | | | | | | | | Hazy | |
| 101 | E5 | Pyraclostrobin | 3 | 90 | 89 | 88 | 86 | 83 | 80 | 77 | 75 | Slightly | Cloudy |
| | | | | | | | | | | | | Hazy | |
| 102 | E6 | Pyraclostrobin | 3 | 89 | 88 | 87 | 84 | 81 | 78 | 76 | 74 | Slightly | Cloudy |
| | | | | | | | | | | | | Hazy | |
| 103 | F1 | Pyraclostrobin | 3 | 58 | 50 | 49 | 48 | 46 | 44 | 43 | 42 | Cloudy | Cloudy |
| 104 | F2 | Pyraclostrobin | 3 | 88 | 85 | 83 | 80 | 77 | 74 | 72 | 70 | Hazy | Slightly |
| | | | | | | | | | | | | | Cloudy |
| 105 | F3 | Pyraclostrobin | 3 | 90 | 89 | 88 | 87 | 86 | 85 | 84 | 84 | Slightly | Slightly |
| | | | | | | | | | | | | Hazy | Cloudy |
| 106 | F4 | Pyraclostrobin | 3 | 91 | 86 | 83 | 78 | 71 | 67 | 63 | 60 | Slightly | Slightly |
| | | | | | | | | | | | | Hazy | Cloudy |
| 107 | F5 | Pyraclostrobin | 3 | 93 | 90 | 87 | 83 | 77 | 73 | 69 | 66 | Slightly | Slightly |
| | | | | | | | | | | | | Hazy | Cloudy |
| 108 | F6 | Pyraclostrobin | 3 | 86 | 79 | 75 | 69 | 61 | 56 | 52 | 48 | Cloudy | Cloudy |
| 109 | A1 | Pyraclostrobin | 10 | 93 | 98 | 98 | 98 | 98 | 98 | 97 | 97 | Clear | Clear |
| 110 | A2 | Pyraclostrobin | 10 | 91 | 92 | 91 | 88 | 85 | 83 | 81 | 80 | Slightly | Cloudy |
| | | | | | | | | | | | | Hazy | |
| 111 | A3 | Pyraclostrobin | 10 | 96 | 98 | 98 | 98 | 98 | 98 | 98 | 98 | Clear | Clear |
| 112 | A4 | Pyraclostrobin | 10 | 93 | 95 | 95 | 95 | 94 | 94 | 93 | 93 | Slightly | Slightly |
| | | | | | | | | | | | | Hazy | Cloudy |
| 113 | A5 | Pyraclostrobin | 10 | 55 | 47 | 49 | 54 | 58 | 59 | 59 | 58 | Cloudy | Cloudy |
| 114 | A6 | Pyraclostrobin | 10 | 94 | 97 | 97 | 97 | 97 | 97 | 97 | 97 | Clear | Clear |
| 115 | B1 | Pyraclostrobin | 10 | 84 | 84 | 81 | 77 | 71 | 66 | 62 | 59 | Slightly | Cloudy |
| | | | | | | | | | | | | Cloudy | |
| 116 | B2 | Pyraclostrobin | 10 | 77 | 63 | 55 | 45 | 36 | 31 | 28 | 25 | Cloudy | Slightly |
| | | | | | | | | | | | | | Cloudy |
| 117 | B3 | Pyraclostrobin | 10 | 74 | 74 | 74 | 75 | 75 | 75 | 76 | 76 | Cloudy | Hazy |
| 118 | B4 | Pyraclostrobin | 10 | 86 | 82 | 79 | 76 | 72 | 68 | 66 | 63 | Slightly | Cloudy |
| | | | | | | | | | | | | Cloudy | |
| 119 | B5 | Pyraclostrobin | 10 | 58 | 49 | 50 | 51 | 50 | 49 | 47 | 46 | Cloudy | Cloudy |
| 120 | B6 | Pyraclostrobin | 10 | 56 | 36 | 34 | 31 | 25 | 20 | 17 | 15 | Cloudy | Cloudy |
| 121 | C1 | Pyraclostrobin | 10 | 78 | 64 | 54 | 42 | 29 | 23 | 19 | 17 | Cloudy | Cloudy |
| 122 | C2 | Pyraclostrobin | 10 | 21 | 3 | 1 | 0 | 1 | 3 | 6 | 9 | Cloudy | Cloudy |
| 123 | C3 | Pyraclostrobin | 10 | 94 | 95 | 95 | 95 | 95 | 95 | 95 | 95 | Clear | Slightly |
| | | | | | | | | | | | | | Hazy |
| 124 | C4 | Pyraclostrobin | 10 | 23 | 3 | 1 | 0 | 0 | 1 | 2 | 4 | Cloudy | Cloudy |
| 125 | C5 | Pyraclostrobin | 10 | 70 | 58 | 51 | 43 | 35 | 30 | 26 | 24 | Cloudy | Cloudy |
| 126 | C6 | Pyraclostrobin | 10 | 34 | 16 | 13 | 9 | 6 | 4 | 3 | 3 | Cloudy | Cloudy |
| 127 | D1 | Pyraclostrobin | 10 | 94 | 98 | 98 | 98 | 98 | 98 | 98 | 98 | Clear | Clear |
| 128 | D2 | Pyraclostrobin | 10 | 93 | 94 | 94 | 95 | 94 | 94 | 95 | 95 | Clear | Clear |
| 129 | D3 | Pyraclostrobin | 10 | 85 | 86 | 87 | 88 | 88 | 88 | 88 | 88 | Cloudy | Hazy |
| 130 | D4 | Pyraclostrobin | 10 | 97 | 98 | 99 | 99 | 98 | 95 | 92 | 89 | Clear | Hazy |
| 131 | D5 | Pyraclostrobin | 10 | 96 | 97 | 97 | 97 | 97 | 97 | 97 | 97 | Clear | Clear |
| 132 | D6 | Pyraclostrobin | 10 | 94 | 95 | 96 | 96 | 96 | 96 | 96 | 96 | Clear | Clear |
| 133 | E1 | Pyraclostrobin | 10 | 76 | 81 | 82 | 83 | 84 | 84 | 84 | 85 | Cloudy | Slightly |
| | | | | | | | | | | | | | Cloudy |
| 134 | E2 | Pyraclostrobin | 10 | 90 | 94 | 94 | 95 | 95 | 95 | 95 | 95 | Hazy | Clear |
| 135 | E3 | Pyraclostrobin | 10 | 92 | 94 | 93 | 93 | 93 | 94 | 94 | 94 | Clear | Clear |
| 136 | E4 | Pyraclostrobin | 10 | 96 | 97 | 97 | 97 | 97 | 98 | 98 | 98 | Clear | Clear |
| 137 | E5 | Pyraclostrobin | 10 | 94 | 97 | 97 | 97 | 97 | 97 | 97 | 97 | Clear | Clear |
| 138 | E6 | Pyraclostrobin | 10 | 98 | 100 | 100 | 100 | 100 | 100 | 100 | 100 | Clear | Clear |
| 139 | F1 | Pyraclostrobin | 10 | 69 | 73 | 75 | 77 | 77 | 77 | 77 | 77 | Cloudy | Cloudy |
| 140 | F2 | Pyraclostrobin | 10 | 93 | 96 | 96 | 96 | 96 | 96 | 97 | 97 | Clear | Clear |
| 141 | F3 | Pyraclostrobin | 10 | 90 | 93 | 93 | 92 | 92 | 91 | 91 | 91 | Slightly | Slightly |
| | | | | | | | | | | | | Hazy | Hazy |
| 142 | F4 | Pyraclostrobin | 10 | 95 | 98 | 98 | 98 | 98 | 98 | 98 | 98 | Clear | Clear |
| 143 | F5 | Pyraclostrobin | 10 | 96 | 97 | 97 | 97 | 97 | 97 | 97 | 97 | Clear | Clear |
| 144 | F6 | Pyraclostrobin | 10 | 91 | 94 | 94 | 94 | 93 | 92 | 91 | 91 | Slightly | Slightly |
| | | | | | | | | | | | | Hazy | Hazy |
| CE1 | | Difenoconazole | | 3 | 2 | 2 | 3 | 9 | 17 | 27 | 32 | Cloudy | Clear, |
| | | | | | | | | | | | | | Sediment |
| CE2 | | Difenoconazole | | 2 | 1 | 1 | 3 | 9 | 18 | 28 | 35 | Cloudy | Clear, |
| | | Replicate | | | | | | | | | | | Sediment |
| CE3 | | Pyraclostrobin | | 2 | 0 | 0 | 1 | 8 | 19 | 32 | 48 | Cloudy | Clear, |
| | | | | | | | | | | | | | Sediment |

### Comparative Examples 4-13 (CE4-CE13)

Following the preparation and characterization procedure described in Examples above, samples of active with polyalkoxylated alcohols of the form Ax-(PO)ₘ-(EO)ₙ—H were prepared at 500 ppm active with 3:1 polymer:active mass ratio. Aliquots of these samples were diluted into deionized water such that the active concentration was 500 ppm, and were immediately analyzed using the Turbiscan. Table 3 shows the sample name, polymer composition, active, and polymer:active ratio, while Table 4 shows the transmission results and the visual observations with time.

The clearing of the samples as measured by an increase in transmission during the later stages of the experiments is due to the sedimentation of the active causes by the failure of the samples.

TABLE 3
Components of comparative examples 4-13

| | | | | | Polymer: |
|---|---|---|---|---|---|
| | Alcohol | | | | Active |
| Sample # | Initiator | (PO)ₘ | (EO)ₙ | Active | by weight |
| CE4 | 2-Ethylhexanol | 5 | 6 | Pyraclostrobin | 3 |
| CE5 | 2-Ethylhexanol | 5 | 9 | Pyraclostrobin | 3 |
| CE6 | 2-Ethylhexanol | 5 | 14 | Pyraclostrobin | 3 |
| CE7 | C8-C14 Linear | 3 | 7 | Pyraclostrobin | 3 |
| | Primary | | | | |
| | Alcohol | | | | |
| CE8 | C8-C14 Linear | 3 | 9 | Pyraclostrobin | 3 |
| | Primary | | | | |
| | Alcohol | | | | |
| CE9 | 2-Ethylhexanol | 5 | 6 | Difenoconazole | 3 |
| CE10 | 2-Ethylhexanol | 5 | 9 | Difenoconazole | 3 |
| CE11 | 2-Ethylhexanol | 5 | 14 | Difenoconazole | 3 |
| CE12 | C8-C14 Linear | 3 | 7 | Difenoconazole | 3 |
| | Primary | | | | |
| | Alcohol | | | | |
| CE13 | C8-C14 Linear | 3 | 9 | Difenoconazole | 3 |
| | Primary | | | | |
| | Alcohol | | | | |

TABLE 4
Summary of transmission results and visual observation
for comparative example 2, Ax-(PO)ₘ-(EO)ₙ-H.

| | | | | | | | | | t = | t = |
|---|---|---|---|---|---|---|---|---|---|---|
| | t = | t = | t = | t = | t = | t = | t = | t = | 0 hr | 24 hr |
| Sample # | 0 hr | 1 hr | 2 hr | 4 hr | 8 hr | 12 hr | 16 hr | 20 hr | (visual) | (visual) |
| units | % T | % T | % T | % T | % T | % T | % T | % T | — | — |
| CE4 | 15 | 7 | 6 | 6 | 6 | 7 | 9 | 11 | Cloudy | Cloudy, |
| | | | | | | | | | | Sediment |
| CE5 | 17 | 8 | 7 | 6 | 7 | 8 | 10 | 13 | Cloudy | Cloudy, |
| | | | | | | | | | | Sediment |
| CE6 | 18 | 8 | 6 | 6 | 7 | 10 | 13 | 16 | Cloudy | Cloudy, |
| | | | | | | | | | | Sediment |
| CE7 | 25 | 12 | 9 | 7 | 7 | 7 | 7 | 8 | Cloudy | Cloudy, |
| | | | | | | | | | | Sediment |
| CE8 | 29 | 12 | 9 | 7 | 7 | 7 | 8 | 9 | Cloudy | Cloudy, |
| | | | | | | | | | | Sediment |
| CE9 | 12 | 8 | 6 | 5 | 3 | 3 | 3 | 4 | Cloudy | Cloudy, |
| | | | | | | | | | | Sediment |
| CE10 | 28 | 11 | 7 | 4 | 3 | 3 | 5 | 7 | Cloudy | Cloudy, |
| | | | | | | | | | | Sediment |
| CE11 | 33 | 11 | 7 | 4 | 3 | 5 | 7 | 11 | Cloudy | Cloudy, |
| | | | | | | | | | | Sediment |
| CE12 | 71 | 74 | 74 | 73 | 71 | 70 | 70 | 69 | Hazy | Cloudy, |
| | | | | | | | | | | Sediment |
| CE13 | 33 | 27 | 23 | 17 | 14 | 14 | 16 | 19 | Cloudy | Cloudy, |
| | | | | | | | | | | Sediment |

The compositions and methods can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

For ranges, stated upper and lower limits can be combined to form ranges (e.g. “at least 1 or at least 2 weight percent” and “up to 10 or 5 weight percent” can be combined as the ranges “1 to 10 weight percent”, or “1 to 5 weight percent” or “2 to 10 weight percent” or “2 to 5 weight percent”). The terms “first,” “second,” and the like, do not denote any order, quantity, or importance, but rather are used to distinguish one element from another. The terms “a” and “an” and “the” do not denote a limitation of quantity and are to be construed to cover both the singular and the plural, unless otherwise indicated herein or clearly contradicted by context. “Or” means “and/or” unless clearly stated otherwise.

Unless specified to the contrary herein, all test standards are the most recent standard in effect as of the filing date of this application, or, if priority is claimed, the filing date of the earliest priority application in which the test standard appears.

The term “alkyl” means a branched or straight chain, unsaturated aliphatic hydrocarbon group, e.g., methyl, ethyl, n-propyl, i-propyl, n-butyl, s-butyl, t-butyl, n-pentyl, s-pentyl, and n- and s-hexyl, or a cycloalkyl, such as cyclohexyl, or alkyls including cyclic groups and straight or branched chains. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Aryl” means an aromatic hydrocarbon group containing the specified number of carbon atoms, such as phenyl, tropone, indanyl, or naphthyl. The prefix “hetero” means that the compound or group includes at least one ring member that is a heteroatom (e.g., 1, 2, or 3 heteroatom(s)), wherein the heteroatom(s) is each independently N, O, S, Si, or P. The number of carbon atoms indicated in a group is exclusive of any substituents. For example —CH₂CH₂CN is a C₂ alkyl group substituted with a nitrile.

1. A composition which is an aqueous composition comprising
an agricultural active ingredient that is water insoluble or poorly soluble in water; a polyalkoxylated alcohol having the formula R—O(AO)—H where R is an alkyl, alkenyl, aryl, aralkyl, or heterocyclic group having 1-25 carbons and where AO is a polyoxyalkylene chain having “m” oxyalkylene groups having four to 10 carbon atoms (HAO) and “n” oxyethylene (EO) groups, where m is at least 1, n is at least 2, and m+n is no more than 200; water; and, optionally, a solvent which is at least partially miscible with water, or both.

2. The composition of claim 1 wherein HAO is oxybutylene (BO).

3. The composition of claim 1 wherein m is from 2 to 10 and n is from 10 to 35.

4. The composition of claim 1 wherein AO is a block copolymer.

5. The composition of claim 1 wherein the AO has an EO rich block and a BO rich block.

6. The composition of claim 1 wherein the solvent is present in an amount of 0.1 to 80 weight percent based on total weight of the composition.

7. The composition of claim 6 wherein the solvent is miscible with water.

8. (canceled)

9. The composition of claim 1 wherein the agricultural active ingredient and the polyalkoxylated alcohol together are present in amounts in the range of 10 ppm to 100 pph.

10. The composition of claim 1 wherein the polyalkoxylated alcohol and the agricultural active ingredient are present in a weight ratio in the range of 0.5:1 to 100:1.

11. The composition of claim 1 where R is an alkyl of 8 to 15 carbon atoms or is an aralkyl of 7-9 carbon atoms.

12. The composition of claim 11 where R is an unsubstituted alkyl of 8, 10, 12 or 15 carbon atoms or is an unsubstituted aralkyl of 9 carbon atoms.

13. A method comprising applying the composition of claim 1 to an area to prevent pests by spraying.

14. The method of claim 13 wherein the composition is diluted with water prior to spraying.

15. The composition of claim 1 wherein n is from 15 to 35.

16. The composition of claim 1 wherein the amount of the polyalkoxylated alcohol is at least 60 weight percent based on total weight of the polyalkyoxylated alcohol and agricultural active.

17. The composition of claim 1 wherein the agricultural active is a bactericide, herbicide, insecticide, miticide, algaecide, nematocide or fumigant.
